(19) United States
(12) Patent Application Publication
(10) Pub. No.: US 2025/0365139 A1
(43) Pub. Date: Nov. 27, 2025

(54) QUANTUM SYSTEM FOR SELF DRIVING CARS

(71) Applicant: Abu Dhabi University, Abu Dhabi (AE)

(72) Inventors: Montasir Yousof Abdallah Qasymeh, Abu Dhabi (AE); Mohammed Abdellatif Abdelaal Zidan, Assuit (EG); Hichem El Euch, Abu Dhabi (AE); AHMED ABDELSHAKOUR METWALY ELFOULY, Sohag (EG)

(73) Assignee: Abu Dhabi University, Abu Dhabi (AE)

(21) Appl. No.: 18/674,907

(22) Filed: May 26, 2024

(51) Int. Cl. H04L 9/08; G06N 10/20

(52) U.S. Cl. CPC H04L 9/0852; G06N 10/20; H04L 9/0861

(57) ABSTRACT

A quantum method that uses the Mz quantum circuit that receives a given single chaotic value to generate strong quantum key stream of three keys. The method includes encrypting a quantum plain color image; applying set of CNOT gates between qubits of a quantum image and qubits of a quantum key to obtain a quantum encrypted image; generating a new quantum key, applying additional set of CNOT gates between the qubits the quantum color image, and the corresponding qubits of the quantum key as target qubits; performing a quantum plain scrambling (QPS) operation; and applying set of CNOT gates; and obtaining, by the quantum circuit, a quantum ciphered image.

### BACKGROUND

The use of self-driving cars is continuously increasing. Self-driving implies that these types of cars should drive themselves autonomously in all conditions. Some of these cars use an artificial intelligence (AI) system to drive based on the outcomes of various cameras and sensors. However, it is possible that when a self-driving car is in motion, one or more of the sensors, or cameras, may experience faults. Accordingly, to minimize or reduce these faults, a self-driving car should be able to securely receive images captured from another camera located in another self-driving car that moves in the same environmental frame.

A wide array of strategies have been developed to secure the process of data transfer. However, when it comes to transferring color images, these existing encryption methods exhibit significant drawbacks, including a considerably longer processing time and a lower generation of random cipher images. Moreover, traditional encryption methods are insecure against quantum computer attackers. There is presently no color image encryption system that is efficient in terms of cost, transmission efficiency, and security against quantum computer attackers.

### BRIEF DESCRIPTION OF DRAWINGS

FIG. 1 is a diagram of an example graph;

FIG. 2 is a diagram of an example graph;

FIG. 3 is a diagram of an example quantum operator;

FIG. 4 is a diagram of an example quantum circuit;

FIG. 5 is a diagram of an example quantum circuit;

FIG. 6 is a diagram of parts of an image;

FIG. 7 is a diagram of an algorithm process;

FIG. 8 is a diagram of an algorithm process;

FIG. 9 is a diagram of an algorithm process;

FIG. 10 is a diagram of a quantum image encryption algorithm;

FIG. 11 is a diagram of an algorithm process;

FIG. 12 is a diagram of an example wire diagram;

FIG. 13 is a diagram of an example wire diagram;

FIGS. 14A and 14B is a diagram describing a quantum algorithm;

FIG. 15 is a diagram of an example image;

FIG. 16 is a diagram of an example encryption process;

FIG. 17 is a diagram of an example table;

FIGS. 18, 19, and 20 are diagrams of example graphs;

FIG. 21 is a diagram of an example table;

FIG. 22 is a diagram of an example histogram;

FIG. 23 is a diagram of an example encryption process;

FIG. 24 is a diagram of an example table;

FIGS. 25A, 25B, 25C, and 25D are diagram of an example decryption process;

FIG. 26 is a diagram of an example table;

FIG. 27 is a diagram of an example table;

FIG. 28 is a diagram of an example computing network environment;

FIG. 29 is a diagram of an example computing device;

FIG. 30 is a diagram of an example computing device; and

FIGS. 31 and 32 are diagrams of quantum circuits.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may provide a variational quantum chaotic encryption process for securing color images and utilizing the chaotic behavior of quantum systems. In embodiments, the quantum chaotic encryption process described herein combines principles from quantum computing and chaos theory which results in a unique framework for secure image transmission. In embodiments, the systems, devices and/or methods described herein utilizes quantum entanglement degrees in conjunction with a one-dimensional chaotic logistic map to generate a stream key of three strong quantum encryption subkeys for encrypting color images. By comparing security metrics with existing classical and quantum encryption mechanisms, the quantum cryptography approach demonstrates superior performance in terms of memory space, security, computational efficiency, and resistance to well-known attacks. Additionally, as described herein, the obtained results validate the key sensitivity, further enhancing its robustness against cryptanalysis.

In embodiments, the quantum image encryption (and decryption) processes described herein may be based on chaotic nonlinear mapping properties controlled by the quantum operator Mz. In embodiments, the Mz operator is a fundamental component for generating a crypto-graphically robust encryption key based on quantum entanglement principles. In embodiments, the integration of the quantum Mz operator behavior with chaotic logistic maps results in a cryptosystem characterized by randomness. As such, this combination the system with remarkable sensitivity to state values and system parameters, thereby ensuring a high level of security.

In embodiments, the methods, systems, and/or devices described herein determine computing processes underpinning our encryption approach. Based on those computing processes, one or more algorithms are described and which are used as part of the encryption methodology. In embodiments, an encryption and decryption process is described along with implementation of a (1-D) logistic map in tandem with the quantum Mz operator. Accordingly, this approach aims to enhance the security and efficiency of the color images encryption process that can be exchanged between moving self-driving cars.

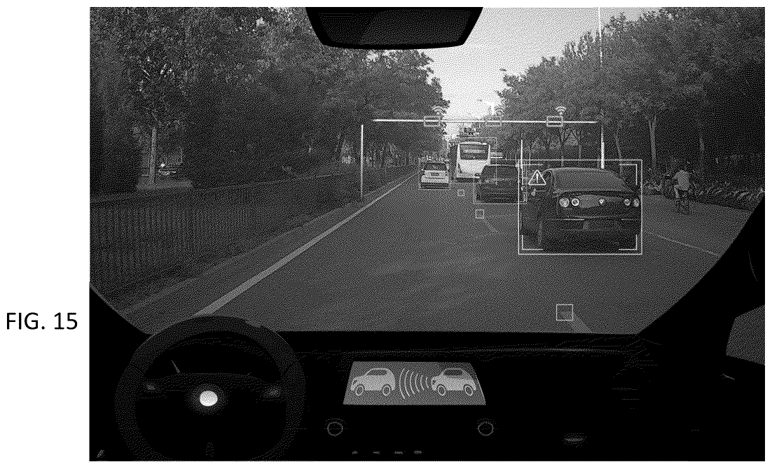

In another example, a self-driving car may have someone unable to manually operate the vehicle. In a particular instance, the camera sensor of this car becomes damaged. To address this issue, the self-driving car may electronically communicate (based on the systems, methods, and/or systems described herein) with another self-driving vehicle traveling on the same road. In this non-limiting example, the electronic communication request sent to the other self-driving vehicle to securely send ciphered images captured by its camera, ensuring protection against both classical and quantum attackers (as also described in FIG. 15). Accordingly, the systems, methods, and/or devices described herein allow for a second self-driving car to send to a first self-driving car images that are captured by a camera device located on the second self-driving car. In embodiments, the second self-driving car uses a quantum encryption on images that are captured in real-time. Using the quantum circuits, described herein, the quantum computer/device (located on the second self-driving car) encrypts the image taken by the camera mounted on the second self-driving car. In embodiments, these images may be known as ciphered images and may be stored in a quantum random access memory of the quantum computer of the second self-driving car. The second self-driving car then sends the ciphered images to the first self-driving car (the receiver) that has a non-functioning camera. The transmission of the ciphered images (from the second self-driving car to the first self-driving car) occurs via a quantum communication channel/network. The first self-driving car receives the quantum ciphered image and stores it in the quantum main memory (quantum random access memory) and then the quantum computer/device on the first self-driving car applies the quantum decryption algorithm (which is executed by the described quantum circuits).

In embodiments, an analysis of encryption and decryption protocols is also determined. Furthermore, the Mz operator-based encryption/decryption process is compared to existing quantum and classical chaotic map-based image encryption techniques. In general, chaotic functions demonstrate nonlinear dynamics, according to statistical analysis. As a result, outcomes are unexpected. Due to their simplicity, the images were encrypted using a one-dimensional logistic chaotic map, whose difference equation (equation 1) is:

$${X}_{i + 1} = {rX}_{i} * ( 1 - {X}_{i} ) \qquad ( 1 )$$

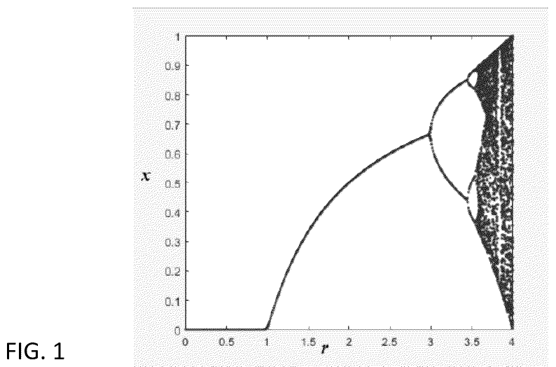

As shown in FIG. 1, the state value Xᵢϵ(0, 1) and a system parameter r∈(0, 4] are specified. In embodiments, the control parameter r has a direct impact on the logistic chaotic map's dynamic behavior. FIG. 1 is an example graph that displays the two-dimensional logistic map bifurcation characteristics for the iterative chaotic sequence X and the control parameter r.

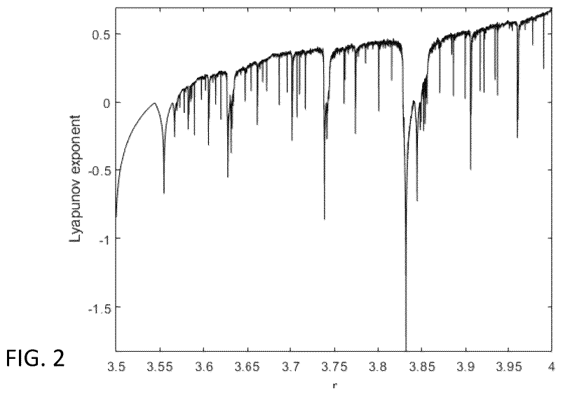

In embodiments, Lyapunov exponents are effective in measuring the performance of a chaotic system. As shown in FIG. 2 (an example electronically generated graph) that the parameter r controls the behavior of the Lyapunov exponents. Additionally, when r=3.56994568, the Lyapunov exponent exceeds 0, indicating the presence of chaotic phenomena within the system. On the other hand, if Lyapunov's exponent is less than 0, then the behavior of the system is non-chaotic (a period window with an oscillating mapping will show up). Thus, the iterative values will be mapped to the entire [0,1] interval when the control parameter r=4, which is referred to as the full mapping state.

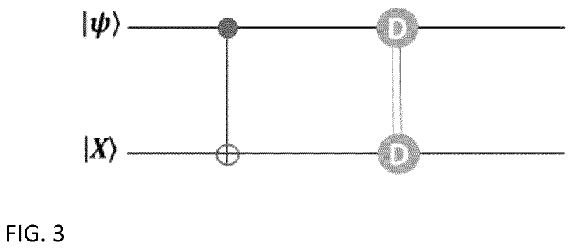

FIG. 3 is an example schematic quantum circuit diagram of the Mz operator. In embodiments, the Mz operator is used for creating the quantum entanglement between two separable qubits followed by the measuring of concurrence C among them using the device D. As shown in FIG. 3, the operator Mz can be characterized as a unitary operator through the implementation of the CNOT gate operation that creates quantum entanglement between the two qubits |ψ [symbol] and |X [symbol] . Subsequently, the entanglement degree among these qubits is measured using the operator D, employing the concurrence measure. To have a deeper comprehension of the Mz operator, it can be elucidated through the utilization of the following analysis. In embodiments, if the state of an unknown single quantum bit system state is as shown in equation (2):

$$\vert Ψ \cdot 〉 = cos ( \frac{θ}{2} ) \vert 0 \cdot 〉 + {e}^{{i}^{φ}} sin ( \frac{θ}{2} ) \vert 1 \cdot 〉 . \qquad ( 2 )$$

Thus, the Mz operator first receives an unknown state as described in equation (2) and the state |X [symbol] =|0 [symbol] . In embodiments, the two-qubit system is transformed into an entanglement state by applying the CNOT gate between the qubits |ψ [symbol] and |X [symbol] , and the state of these two qubits is described by equation (3):

$$\vert {Ψ}_{1} \cdot 〉 = cos ( \frac{θ}{2} ) \vert 00 \cdot 〉 + {e}^{{i}^{φ}} sin ( \frac{θ}{2} ) \vert 11 \cdot 〉 . \qquad ( 3 )$$

In embodiments, an operator D is employed to measure the degree of entanglement between these qubits, resulting in the concurrence value (Cϵ[0, 1]). When the basis state is |ψ [symbol] =|0 [symbol] , or |ψ [symbol] =|1 [symbol] the Mz operator results does not create entanglement between these two qubits |ψ [symbol] and |x [symbol] , leaving them in the state |Ψ [symbol] |X [symbol] =|00 [symbol] , or |Ψ|X [symbol] =|11 [symbol] . Subsequently, the measurement performed by the operator D yields a value of C=0.

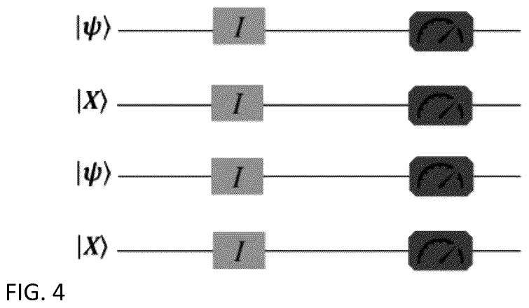

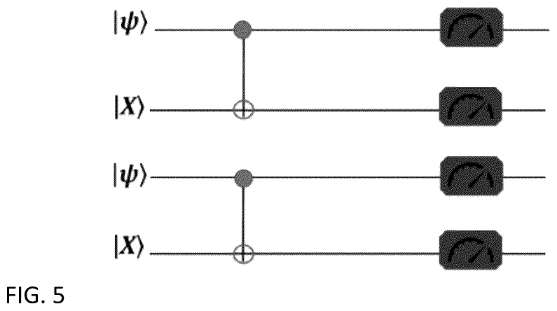

FIG. 4 is an example schematic diagram of a quantum circuit the D operator that measures the degree of entanglement between two qubits |Ψ|X [symbol] . FIG. 5 is an example diagram of a quantum circuit of the Mz operator which operates according to the following steps: (1) given

$$\vert Ψ \cdot 〉 = cos ( \frac{θ}{2} ) \vert 0 \cdot 〉 + sin ( \frac{θ}{2} ) \vert 1 \cdot 〉$$

and |X [symbol] =|0 [symbol] ; (2) apply the CNOT gate between the qubits |ψ [symbol] and |X [symbol] ,

$$\vert {Ψ}_{1} \cdot 〉 = cos ( \frac{θ}{2} ) \vert 00 \cdot 〉 + sin ( \frac{θ}{2} ) \vert 1 \cdot 〉 ,$$

and (3) to measure the degree of entanglement: Creating an additional decoupling replica of the two-qubit state and measuring concurrence by using the operator D: |η [symbol] =|Ψ₁⋅ [symbol] ⊗|Ψ₁⋅ [symbol] . Here, it is important to note that the non-cloning theorem is not violated because the two replicas are created independently and autonomously. By initializing each system from scratch and then applying the same quantum operations independently. Thus, at step (4), the system is measured to determine the likelihood of observing the states |0011 [symbol] or |1100 [symbol] . Consequently, the concurrence value C can be computed with equation (4) as follows:

$$C = 2 \sqrt{{P}_{0011}} , C = 2 \sqrt{{P}_{1100}} , or C = \sqrt{2 ( {P}_{0011} + {P}_{1100} ) .} \qquad ( 4 )$$

As shown in equation (4), P₀₀₁₁, and P₁₁₀₀ are the success probabilities for the basis states |0011 [symbol] and |1100 [symbol] , respectively. In embodiments, the quantum circuit is depicted in FIG. 3 can be modified by applying the operator D, as shown in FIG. 4 which is another schematic diagram of another quantum circuit. In embodiments, this modification by the quantum circuit shown in FIG. 5 generates a quantum circuit diagram for the Mz. In embodiments, the quantum operator Mz, described by FIG. 5, may be used to generate a strong encryption key based on the degree of quantum entanglement.

In embodiments, the NEQR technique is a quantum algorithm may be used to map classical color image into quantum image as a superposition of quantum basis states. With this approach, the value of each channel in an RGB (Red Green Blue) pixel contains 8 qubits, for a total of 24 basic states. In embodiments, the controlled rotation gates are then used to change each of these 24 qubits from their initial state to a superposition state. Every pixel's RGB grayscale values are currently balanced and superposed in a multi-qubit state. NEQR image |I [symbol] of size M×N is written in equation (5) as follows:

$$\vert I 〉 = \frac{1}{\sqrt{{2}^{n + m}}} {\sum }_{Y = 0}^{{2}^{m} - 1} {\sum }_{X = 0}^{{2}^{n} - 1} \vert I ( {Y}^{R} , {X}^{R} ) , I ( {Y}^{G} , {X}^{G} ) , I ( {Y}^{B} , {X}^{B} ) 〉 \vert YX 〉 , \qquad ( 5 )$$

where m=log₂ M, and n=log₂ N.

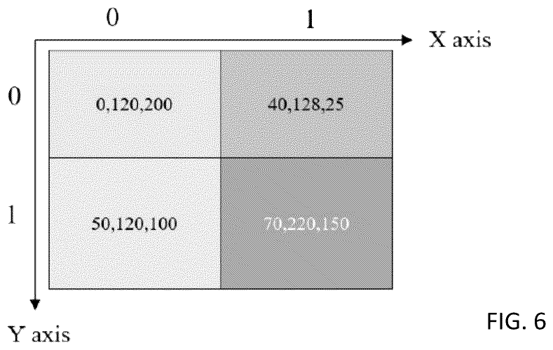

In embodiments, as shown in equation (5), the quantum registers |I(Y^{R}, X^{R}), I(Y^{G}, X^{G}), I(Y^{B}, X^{B}) [symbol] represents qubits that encode the intensities of the red, green, and blue channels. In embodiments, the register |Y⋅ [symbol] is of size m qubits, and the register |X⋅ [symbol] is of size n qubits that are used to denote the pixel location in the corresponding image. FIG. 6 is an example of an image I of the size 2×2, which can be implemented by NEQR. In embodiments, given the quantum image |I [symbol] expression may be described by equation (6) as follows:

$$\begin{matrix}\vert I 〉 = \frac{1}{2} ( \vert 00000000 , 01111000 , 11001000 〉 ⊗ \vert 00 〉 + \vert 00101000 , 10000000 , 00011001 〉 \\ ⊗ \vert 01 〉 + \vert 00110010 , 01111000 , 01100100 〉 ⊗ \vert 10 〉 \\ + \vert 01000110 , 11011100 , 10010110 〉 ⊗ \vert 11 〉 ) .\end{matrix} \qquad ( 6 )$$

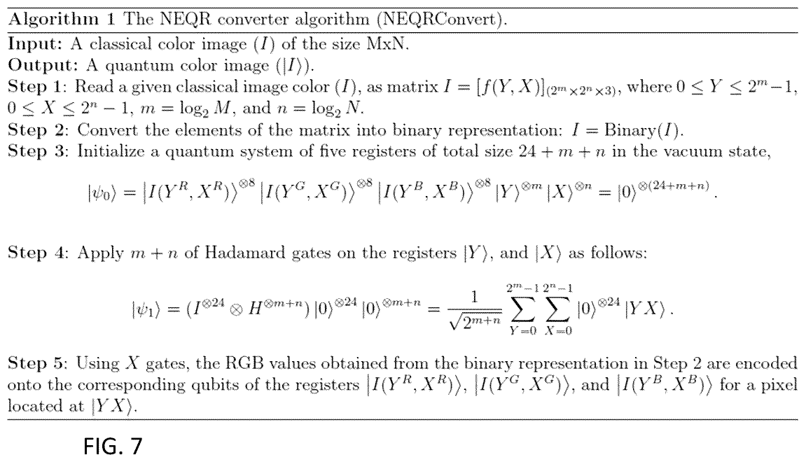

FIG. 7 is an example diagram describing the steps of the NEQR algorithm that is used to convert a given classical image into a quantum color image, or to convert a given classical key into a quantum key state.

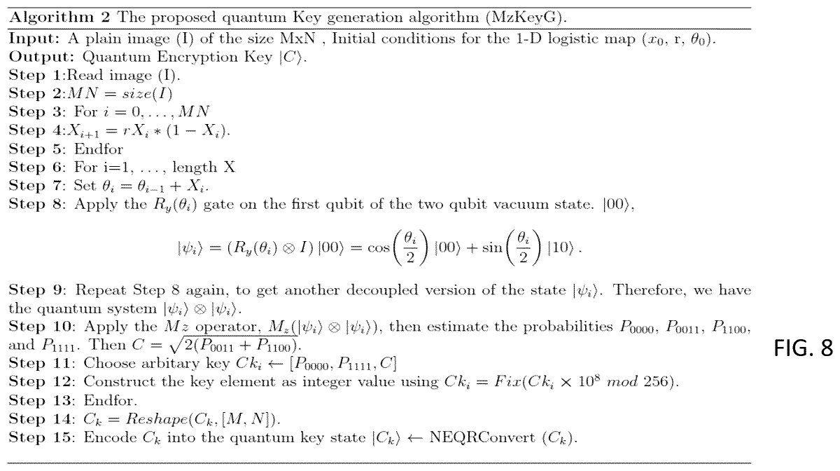

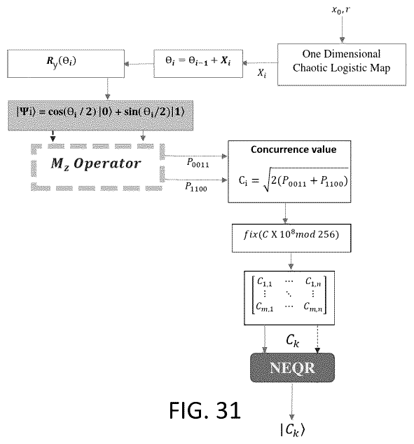

FIG. 8 describes the proposed quantum key generation algorithm (MzKeyG) that generates a robust quantum key stream of three quantum keys using the Mz operator when receiving output from a one-dimensional chaotic map. FIG. 31 further explains an example of the quantum key generation algorithm by describing the schematic wired circuit of the proposed quantum Key generation algorithm (MzKeyG). In embodiments, Step 1, the system reads a given classical image, then the size of this image is determined in Step 2.

In embodiments, for a given image of size N×M, a one-dimensional chaotic logistic map is used to generate N×M chaotic values. A map algorithm is a computational method that uses the logistic map described in equation (1) to generate chaotic sequences. In embodiments, as shown in FIG. 8, this algorithm includes steps (3-5) which generates sequence numbers stored in X using equation (1). Since X is an array of floating values, by repeating this step N×M times, a full chaotic state can be achieved.

In embodiments, steps (6-13) generate the quantum encryption key stream for each pixel i based on the success probabilities of the basis states |0011 [symbol] , |1100 [symbol] , and the degree of entanglement measure, concurrence Cᵢ, in step (7), the angle θᵢ is updated by adding Xᵢ, where θ₀=0. In step (8) encodes θᵢ into the first qubit of a two qubit system that is initialized in the vacuum state |00 [symbol] by the Y-rotation gate R_{y}(θᵢ) on the first qubit. Then state of this two-qubit is

$$cos ( \frac{{θ}_{i}}{2} ) \vert 00 \cdot 〉 + sin ( \frac{{θ}_{i}}{2} ) \vert 10 \cdot 〉 .$$

The R_{y}(θᵢ) gate performs a rotation for a single qubit by an amount

$$\frac{{θ}_{i}}{2}$$

around the y-axis or the Bloch sphere.

Step (9) reiterate step (8) once again to create four spreadable qubits as follows:

$$\begin{matrix}\vert ψ \cdot 〉 \vert ψ \cdot 〉 = {cos}^{2} ( \frac{{θ}_{i}}{2} ) \vert 0000 \cdot 〉 \\ + cos ( \frac{{θ}_{i}}{2} ) sin ( \frac{{θ}_{i}}{2} ) \vert 0010 \cdot 〉 + cos ( \frac{{θ}_{i}}{2} ) sin ( \frac{{θ}_{i}}{2} ) \vert 1000 \cdot 〉 \\ + {sin}^{2} ( \frac{{θ}_{i}}{2} ) \vert 1010 \cdot 〉 .\end{matrix}$$

Step (10) applies the Mz operator on the four qubits, by applying two CNOT gates that entangle two decoupled replicas of |ψ [symbol] |ψ [symbol] as follows:

$$\begin{matrix}\vert ψ \cdot 〉 \vert ψ \cdot 〉 = {cos}^{2} ( \frac{{θ}_{i}}{2} ) \vert 0000 \cdot 〉 \\ + cos ( \frac{{θ}_{i}}{2} ) sin ( \frac{{θ}_{i}}{2} ) \vert 0011 \cdot 〉 + cos ( \frac{{θ}_{i}}{2} ) sin ( \frac{{θ}_{i}}{2} ) \vert 1100 \cdot 〉 \\ + {sin}^{2} ( \frac{{θ}_{i}}{2} ) \vert 1111 \cdot 〉 .\end{matrix}$$

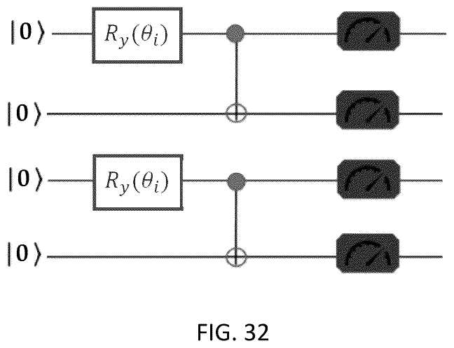

In embodiments, this operator measures these four qubits and estimates the concurrence value Cᵢ by equation (4) using the probabilities of the basis states |0000 [symbol] , |0011 [symbol] , |1100 [symbol] , and |1111 [symbol] in step (10). FIG. 32 further describes the quantum circuit of steps (8-10). Hence, the Mz operator used the classical chaotic value θᵢ to generate a key stream of three encryptions keys, namely P₀₀₀₀, P₁₁₁₁, and Cᵢ=\sqrt{2(P₀₀₁₁+P₁₁₀₀)}. Here, any key of these three keys can be used arbitrary to encrypt the image. In embodiments, at step (11) may choose the key Ckᵢ=\sqrt{2(P₀₀₁₁+P₁₁₀₀)}. At step (12), the key is transformed into integer values between [0,255] using the formula Ckᵢ=Fix(Ckᵢ×10⁸ mod 256). After steps (6-13) terminate, the keys array C of size MN×1 is obtained. To convert this array into the matrix C of size M×N, then step (14) is executed. Finally, in step (15) this matrix C is converted into a quantum key using the NEQR algorithm, the quantum state of the generated key is as follows:

$$\vert C 〉 = \frac{1}{\sqrt{{2}^{n + m}}} {\sum }_{Y = 0}^{{2}^{m} - 1} {\sum }_{X = 0}^{{2}^{n} - 1} \vert C ( {Y}^{R} , {X}^{R} ) , C ( {Y}^{G} , {X}^{G} ) , C ( {Y}^{B} , {X}^{B} ) 〉 \vert YX 〉 .$$

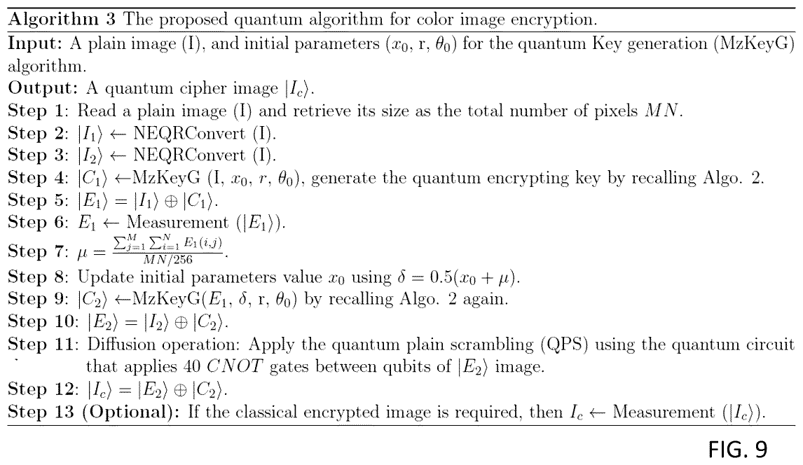

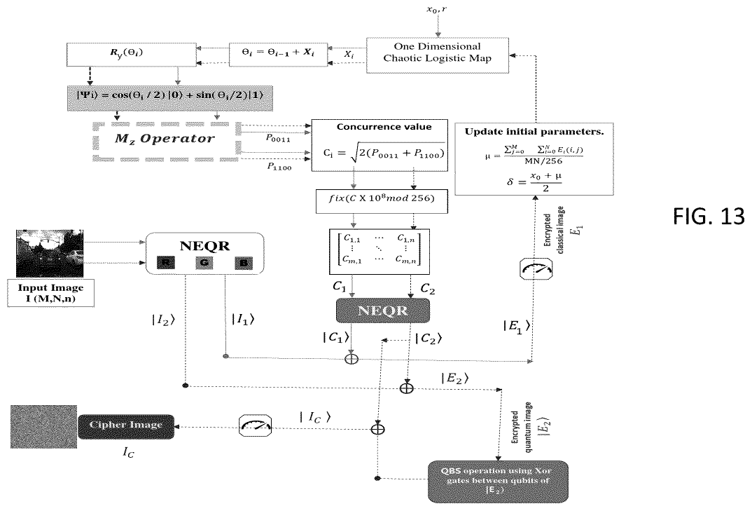

Thus, the proposed quantum encryption method relies on two quantum phase processes involving quantum confusion and quantum diffusion operations. FIG. 13 explains an example of the schematic wired diagram of the proposed variational quantum encryption method. FIG. 9 is a diagram of an example quantum algorithm that describes shows steps of a cryptosystem's encryption process. Step (1) reads a given plain classical image I that is needed to be encrypted.

Steps (2) and (3) convert this plain image I into two quantum identical plain images |I₁ [symbol] , and |I₂ [symbol] using the NEQR algorithm that is explained in FIG. 7. This step does not violate the no-cloning theorem because the copying is performed via classical systems, and then each copy is converted into quantum images independently. After this step, two quantum images are constructed, namely |I₁ [symbol] , and |I₂ [symbol] , respectively, such that |I₁ [symbol] =|I₂ [symbol] .

Step (4) generates a quantum encrypted key |C₁ [symbol] based on the degree of entanglement by calling the MzKeyG algorithm that is explained in FIG. 8. The state of the key |C₁ [symbol] is described by equation (7):

$$\vert {C}_{1} 〉 = \frac{1}{\sqrt{{2}^{n + m}}} {\sum }_{Y = 0}^{{2}^{m} - 1} {\sum }_{X = 0}^{{2}^{n} - 1} \vert {C}_{1} ( {Y}^{R} , {X}^{R} ) , {C}_{1} ( {Y}^{G} , {X}^{G} ) , {C}_{1} ( {Y}^{B} , {X}^{B} ) 〉 \vert YX 〉 . \qquad ( 7 )$$

By applying Steps (5) to (10), the variational quantum confusion operation is performed. Step (5) applies 24 of CNOT gates between qubits of the three registers |I₁(Y^{R}, X^{R}), I₁(Y^{G}, X^{G}), I₁(Y^{B}, X^{B})) of the quantum image |I₁ [symbol] as control qubits, and the corresponding qubits of the three registers |C₁(Y^{R}, X^{R}), C₁(Y^{G}, X^{G}), C₁(Y^{B}, X^{B}) [symbol] of the quantum key |C₁ [symbol] as the target qubits, respectively. This process generates the quantum-encrypted image |E₁ [symbol] to obtain the quantum encrypted image |E₁ [symbol] that has the following state:

$$\vert {E}_{1} 〉 = \frac{1}{\sqrt{{2}^{n + m}}} {\sum }_{Y = 0}^{{2}^{m} - 1} {\sum }_{x = 0}^{{2}^{n} - 1} \vert {E}_{1} ( {Y}^{R} , {X}^{R} ) , {E}_{1} ( {Y}^{G} , {X}^{G} ) , {E}_{1} ( {Y}^{B} , {X}^{B} ) 〉 \vert YX 〉 .$$

Then, Step (6) measures the quantum encrypted images typically |E₁ [symbol] to transform it into a classical encryption image E₁.

Step (7) estimates a parameter μ using as

$$μ = \frac{{\sum }_{i = 1}^{M} {\sum }_{j = 1}^{N} {E}_{1} ( i , j )}{MN / 256} ,$$

where MN is the total number of pixels of the encrypted image E₁. Then, step (8) updates the initial parameter x₀ using δ=0.5(x₀+μ).

Step (9) uses the classical encrypted image E₁, and the paramters δ, r, θ₀ to generate a new quantum key |C₂ [symbol] by re-executing the MzKeyG system that is explained in FIG. 8. The state of the quantum key |C₂ [symbol] is as follows:

$$\vert {C}_{2} 〉 = \frac{1}{\sqrt{{2}^{n + m}}} {\sum }_{Y = 0}^{{2}^{m} - 1} {\sum }_{X = 0}^{{2}^{n} - 1} \vert {C}_{2} ( {Y}^{R} , {X}^{R} ) , {C}_{2} ( {Y}^{G} , {X}^{G} ) , {C}_{2} ( {Y}^{B} , {X}^{B} ) 〉 \vert YX 〉 .$$

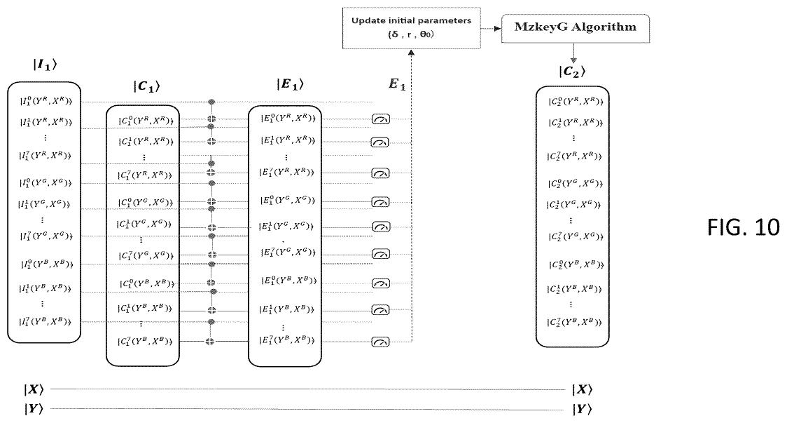

In embodiments, FIG. 10 explains the quantum circuit blocks of Steps 5-9.

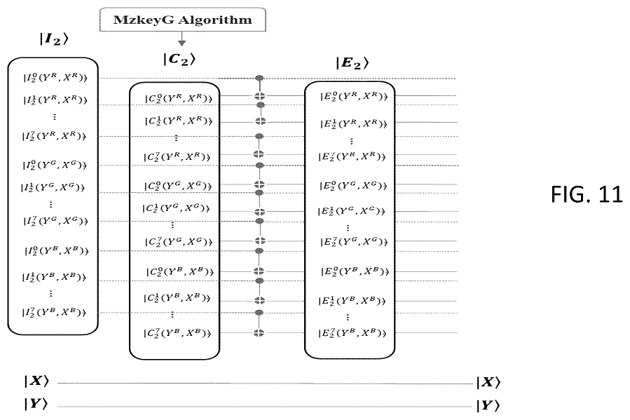

The new quantum key |C₂ [symbol] obtained in Step (9) is utilized to finish the confusion operations in step (10). In embodiments, FIG. 11 shows the quantum circuit block of Step (10), it involves applying 24 CNOT gates between the qubits of the three registers |I₂(Y^{R}, X^{R}), I₂(Y^{G}, X^{G}), I₂(Y^{B}, X^{B}) [symbol] of the quantum image |I₂ [symbol] as control qubits, and the corresponding qubits of the three registers |C₂(Y^{R}, X^{R}), C₂(Y^{G}, X^{G}), C₂(Y^{B}, X^{B}) [symbol] , respectively, of the quantum key |C₂ [symbol] as target qubits. This step generates the second level of the quantum-encrypted image, denoted as |E₂ [symbol] , with the following state:

$$\vert {E}_{2} 〉 = \frac{1}{\sqrt{{2}^{n + m}}} {\sum }_{Y = 0}^{{2}^{m} - 1} {\sum }_{X = 0}^{{2}^{n} - 1} \vert {E}_{2} ( {Y}^{R} , {X}^{R} ) , {E}_{2} ( {Y}^{G} , {X}^{G} ) , {E}_{2} ( {Y}^{B} , {X}^{B} ) 〉 \vert YX 〉 .$$

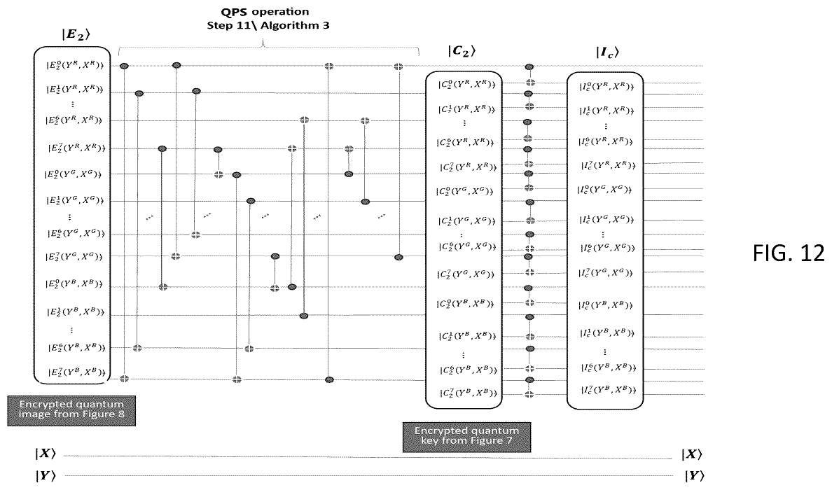

The quantum diffusion operation aims to enhance the security level of the quantum-encrypted image |E₂ [symbol] derived from the encryption image. Consequently, a new version of the quantum-encrypted image |I_{c} [symbol] is generated. At step (11), a new approach called quantum plain scrambling (QPS) quantum circuit is proposed to perform bit plain scrambling (BPS) operation quantum mechanically on the quantum image |E₂ [symbol] . In embodiments, the proposed QPS is performed using a set of CNOT gates between the red channel qubits, the green channel qubits, and the blue channel qubits through the following sub-steps: first, a number of 8 CNOT gates are applied, where each CNOT gate is applied between the qubit with index i in the quantum red channel as the control qubit and the qubit with index 7−i in the quantum blue channel as the target qubit. Synchronously, another set of 8 CNOT gates is applied, where each CNOT gate is applied between the qubit with index i in the quantum red channel as the control qubit and the qubit with index 7−i in the quantum green channel as the target qubit. Then, a number of 8 CNOT gates are applied, where each CNOT gate is applied between the qubit with index i in the quantum green channel as the control qubit and the qubit with index 7−i in the quantum blue channel as the target qubit. In the second sub-step, a number of 8 CNOT gates are applied, where each CNOT gate is applied between the qubit with index i in the quantum blue channel as the control qubit and the qubit with index 7−i in the quantum red channel as the target qubit. Finally, a number of 8 CNOT gates are applied, where each CNOT gate is applied between the qubit with index i in the quantum green channel as the control qubit and the qubit with index 7−i in the quantum red channel as the target qubit. In all of these sub-steps, i=0, 1, 2, . . . , 7. The quantum circuit block that depicts the proposed QPS approach, step (11), is explained in FIG. 12.

Step (12) applies 24 of CNOT gates (one CNOT gate for each qubit in the three quantum channels RGB) between each qubit of the quantum scrambling image |E₂ [symbol] as the control qubits and its corresponding qubit in the quantum key |C₂ [symbol] as the target qubits. Hence, the quantum ciphered/encrypted image |I_{c} [symbol] is obtained. FIG. 12 explains the quantum circuit of Steps 11-1. The state of the quantum ciphered/encrypted image |I_{c} [symbol] is

$$\vert {I}_{c} 〉 = \frac{1}{\sqrt{{2}^{n + m}}} {\sum }_{Y = 0}^{{2}^{m} - 1} {\sum }_{X = 0}^{{2}^{n} - 1} \vert {I}_{c} ( {Y}^{R} , {X}^{R} ) , {I}_{c} ( {Y}^{G} , {X}^{G} ) , {I}_{c} ( {Y}^{B} , {X}^{B} ) 〉 \vert YX 〉 .$$

Here, thus the ciphered/encrypted image |I_{c} [symbol] can be transmitted directly to a receiver via quantum communication channel or classical network. Thus, if there is a need to transfer it through a classical network, then step (13) is executed that measures the ciphered/encrypted image |I_{c} [symbol] to obtain the corresponding classical ciphered image I_{c}.

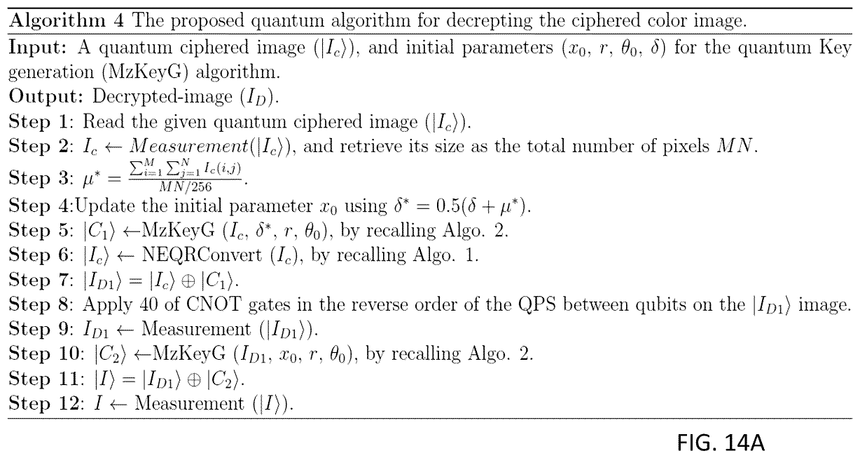

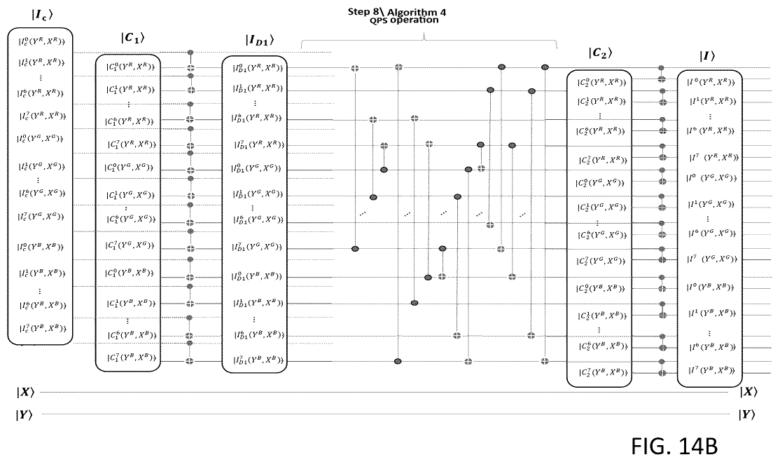

FIG. 13 explains an example the schematic wired diagram of the proposed variational quantum encryption algorithm that is described in FIG. 9. Then, when a receiver receives an encrypted quantum image |I_{c} [symbol] , the quantum decryption algorithm described herein is used to recover the original plaintext image. Accordingly, the proposed quantum decryption algorithm is further described which retrieves the original plaintext image I that was encrypted using algorithm 3. In embodiments, the steps of the proposed decryption algorithm are outlined in Algorithm 4 as shown in FIG. 14A.

The proposed decryption algorithm retrieves the original plaintext image from the quantum ciphered image |I_{c} [symbol] through two rounds of decryption phases. As described in FIG. 14A, the detailed explanation of the steps involved in the proposed quantum decryption algorithm is as follows: Step (1) reads a given quantum ciphered image |I_{c} [symbol] that is needed to be decrypted; step (2) involves measuring the quantum ciphered image |I_{c} [symbol] at hand in the computational basis, resulting in the transformation of |I_{c} [symbol] into a classical encrypted image, denoted as I_{c}, and retrieving its size as the total number of pixels MN; step (3) estimates a parameter μ* using the formula

$${μ}^{*} = \frac{{\sum }_{i = I}^{M} {\sum }_{j = 1}^{N} {I}_{c} ( i , j )}{MN / 256} . \qquad ( 8 )$$

In equation (8), MN represents the total number of pixels in the encrypted image I_{c}. Subsequently, in step (4), described in FIG. 14A, the initial parameter x₀ is updated using the formula δ*=0.5(δ+μ*).

Step (5) of FIG. 14A uses the classical ciphered image I_{c} and the parameters δ*, r, and θ₀ to generate a quantum decrypting key |C₁ [symbol] by executing the MzKeyG algorithm (Algorithm 2 as described in FIG. 8). In embodiments, the state of |C₁ [symbol] is described by equation (7).

Step (6) converts the classical ciphered image I_{c} into the quantum image |I_{c} [symbol] using the NEQRConvert (Algorithm 1 as described in FIG. 7).

Step (7), in FIG. 14A, generates the first round of the quantum decryption phase, |I_{D1} [symbol] , by applying 24 CNOT gates between the qubits of the three registers: |I_{c}(Y^{R}, X^{R}) [symbol] , |I_{c}(Y^{G}, X^{G}) [symbol] , and |I_{c}(Y^{B}, X^{B}) [symbol] of the quantum image |I_{c} [symbol] as control qubits, and the corresponding qubits of the three registers: |C₁(Y^{R}, X^{R}) [symbol] , |C₁(Y^{G}, X^{G}) [symbol] , and |C₁(Y^{B}, X^{B}) [symbol] of the quantum key |C₁ [symbol] as target qubits. Then, the quantum state of the image |I_{D1} [symbol] is as follows:

$$\vert {I}_{D 1} 〉 = \frac{1}{\sqrt{{2}^{n + m}}} {\sum }_{Y = 0}^{{2}^{m} - 1} {\sum }_{X = 0}^{{2}^{n} - 1} \vert {I}_{D 1} ( {Y}^{R} , {X}^{R} ) , {I}_{D 1} ( {Y}^{G} , {X}^{G} ) , {I}_{D 1} ( {Y}^{B} , {X}^{B} ) 〉 \vert YX 〉 .$$

Step (7) is explained in the quantum circuit that is shown in FIG. 14B.

At step (8), of FIG. 14A, reverse the effect of the quantum plain scrambling (QPS) quantum circuit that was used in the encryption algorithm (explained in FIG. 9) by applying the quantum circuit that is explained in FIG. 14B to the quantum image |I_{D1} [symbol] . This quantum circuit applies 40 CNOT gates between the qubits of the red, green, and blue channels of the state |I_{D1} [symbol] as follows: First A series of eight CNOT gates is applied. Each CNOT gate connects the qubit at index i in the quantum green channel as the control qubit to the qubit at index 7−i in the quantum red channel as the target qubit. Simultaneously, another set of eight CNOT gates is applied, where each CNOT gate connects the qubit at index i in the quantum blue channel as the control qubit to the qubit at index 7−i in the quantum red channel as the target qubit. Additionally, a set of eight CNOT gates is applied, where each CNOT gate connects the qubit at index i in the quantum green channel as the control qubit to the qubit at index 7−i in the quantum blue channel as the target qubit. Additionally, a set of eight CNOT gates is applied, where each CNOT gate connects the qubit at index i in the quantum red channel as the control qubit to the qubit at index 7−i in the quantum green channel as the target qubit. Next, a set of eight CNOT gates is applied, with each CNOT gate connecting the qubit at index i in the quantum red channel as the control qubit to the qubit at index 7−i in the quantum blue channel as the target qubit, where i=0, 1, . . . , 7.

Step (9) of FIG. 14A measures the quantum image |I_{D1} [symbol] in the computational basis, resulting in the transformation of |I_{D1} [symbol] into a classical image I_{D1}.

Step (10) of FIG. 14A uses the classical ciphered image I_{D1} and the parameters x₀, r and θ₀ to generate a quantum decrypting key |C₂ [symbol] by executing the MzKeyG algorithm (Algorithm 2 as described in FIG. 8).

Step (11) of FIG. 14A generates the second round of the quantum decryption phase, resulting in the required plaintext image |I [symbol] . This is achieved by applying 24 CNOT gates between the qubits of the three registers: |I_{D1}(Y^{R}, X^{R}) [symbol] , |I_{D1}(Y^{G}, X^{G}) [symbol] , and |I_{D1}(Y^{B}, X^{B}) [symbol] of the quantum image |I_{D1} [symbol] as control qubits, and the corresponding qubits of the three registers: |C₁(Y^{R}, X^{R}) [symbol] , |C₂(Y^{G}, X^{G}) [symbol] , and |C₂(Y^{B}, X^{B}) [symbol] , respectively, of the quantum key |C₂ [symbol] as target qubits. The quantum state of the retrieved plain text image is described by equation (6). Step (11) is explained in the quantum circuit that is shown in FIG. 14B.

Finally, in Step (12) of FIG. 14A measures the plain quantum image |I [symbol] in the computational basis, to get the classical original image I.

In embodiments, the encryption and decryption processes described above may be used for self-driving cars. In embodiments, autonomous vehicles are reliant on sensors and AI systems to operate, making them vulnerable to a range of threats, including hacking, accidents, and environmental factors. In a non-limiting example, a self-driving car may have a damaged camera. Thus, the systems, methods, and/or devices described herein may provide images securely sent from another vehicle to send images securely to the vehicle with the damaged vehicle. Hence, these two cars use the quantum cryptography system to exchange in between in real-time as shown in FIG. 15.

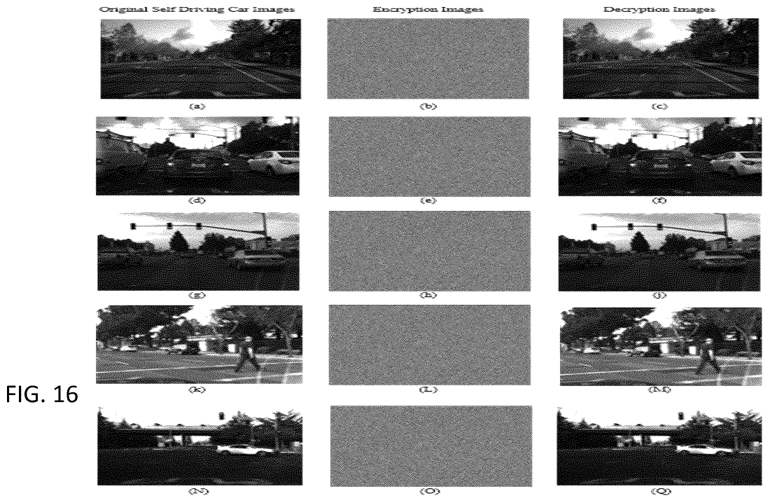

In embodiments, the sender autonomous car (the car sending the secured image) may use Algorithm 3 to encrypt images, and the other autonomous car (the vehicle receiving the secured image) may use Algorithm 4 to decrypt received images. In embodiments, to analyze the performance of the proposed algorithm, five distinct images are obtained from a self-driving data set [43]. It is chosen to encrypt images using the typical road, red-signal, green-signal people-road and under-bridge of 512×512 images in FIG. 16 (a, d, g, k, and N). The suggested Algorithm 3 is employed to encrypt the original images displayed in FIG. 16, (b, e, h, L and O) shows the encrypted images that were produced. As shown in FIG. 16, the figure demonstrates how the suggested encryption method scrambles the original image without leaving any traces that can be used to decode the original data. In embodiments, the proposed image decryption method is opposite to encryption Algorithm 3 which is subsequently used to execute the decryption, is shown in FIG. 16 (c, f and j, M and Q). In embodiments, the decryption outcome indicates a successful recovery of the original image.

In embodiments, the systems, methods, and/or devices are used to determine the settings under which the encryption and encryption processes.

In embodiments, the magnitude of a keyspace holds significance in the encryption procedure. When the size of the keyspace exceeds 2¹⁰⁰, the encryption method shows that brute-force attacks can't break it. In embodiments, the proposed encryption Algorithm 3. incorporates various security keys, resulting in a total keyspace that surpasses 2. Thus, this characteristic serves as evidence of its ability to withstand brute-force attacks. In embodiments, an assessment of the effectiveness and the performance of the proposed quantum chaotic color image encryption approach and a comparison with other state-of-the-art approaches when subjected to various statistical attacks.

This area illustrates the interconnections between nearby pixels in the plaintext image and their ciphered counterparts. As shown below, equation (7) is used to measure how strong a relationship is between nearby pixels, taking into account their horizontal, vertical, and diagonal orientations.

$${r}_{xy} = \frac{E ( ( x - E ( x ) ) ( y - E ( y ) ) )}{\sqrt{D ( x ) D ( y )}} \qquad ( 7 )$$

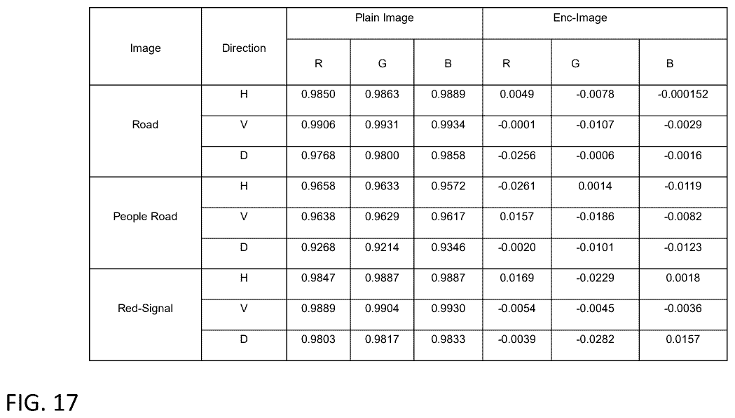

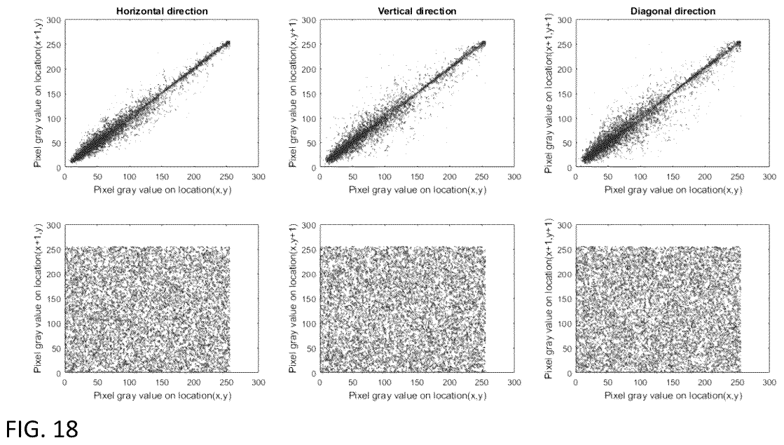

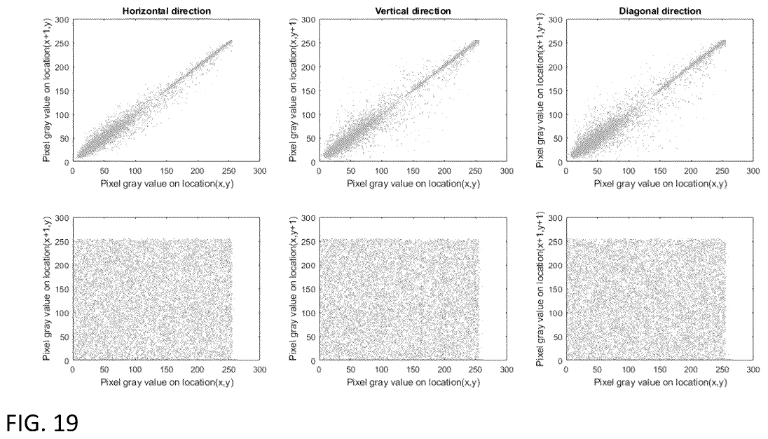

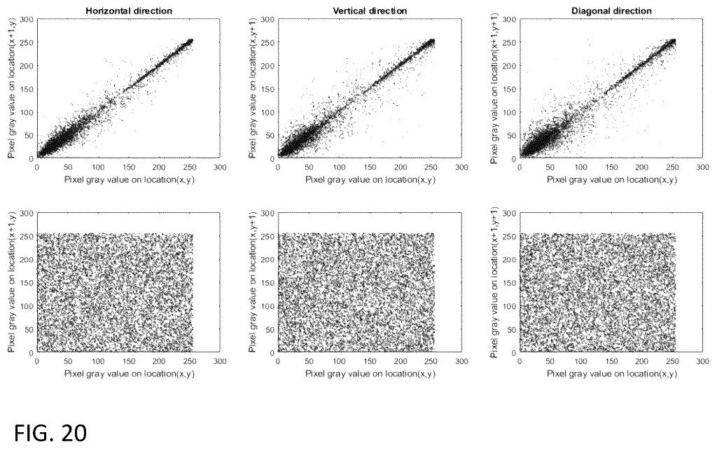

In embodiments, for equation (7), x and y the pixel values of two nearby pixels. As shown in FIG. 17, a table presents the correlation distribution of 10,000 randomly selected original images with their encrypted counterparts. As shown in FIG. 1, the correlation factor for the original images exhibits a strong positive association, with values approaching 1. In contrast, correlation factors close to zero show that the encrypted images show a weak or negligible association. FIGS. 18, 19, and 20 are example graphs that shows a correlation in encrypted road image components. Based on these example graphs, the described encryption process has decreased absolute correlation coefficients.

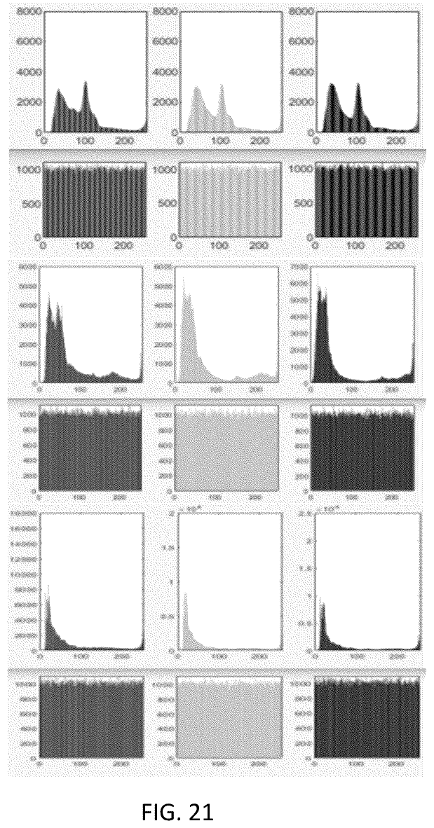

FIG. 21 describes example histograms describing distribution of the image's pixel values. As shown in FIG. 21, histograms for road, people road, and red signal images. As shown in FIG. 21, the distribution of the cipher image is predominantly uniform and level, similar to that of random data. In contrast, the normal image does not display uniformity. Accordingly, this indicates that the encryption process described herein is resistant to statistical attacks.

As shown in equation (8), information entropy (IE) quantifies the unpredictable nature of an image as follows:

$$H ( m ) = {\sum }_{i} P ( {m}_{i} ) {log}_{2} \frac{1}{P ( {m}_{i} )}$$

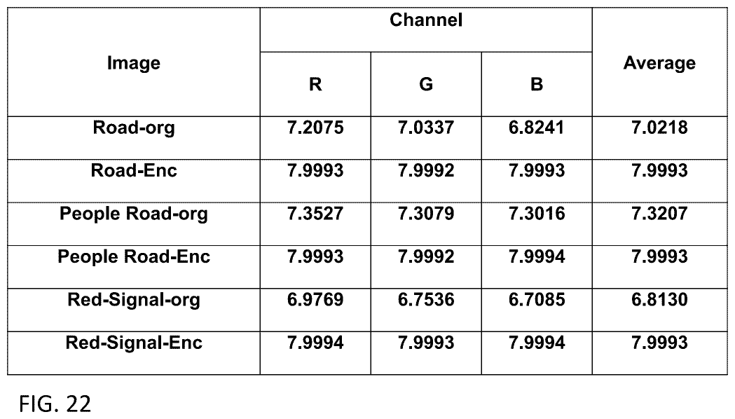

As described in equation (8), the probability of the occurrence of mᵢ is denoted as P (mᵢ). In embodiments, the method we have developed is evaluated using a set of three images, each with dimensions of 512×512 pixels, which were selected from datasets related to self-driving cars. As shown in FIG. 22, a table is shown that describes the average entropy measurements for test images and their enciphered color image that closely approximates the desired value of 8. Therefore, the encrypted images using the proposed encryption process have the highest randomness. As a result, it is extremely difficult to extract visual information from such encrypted images.

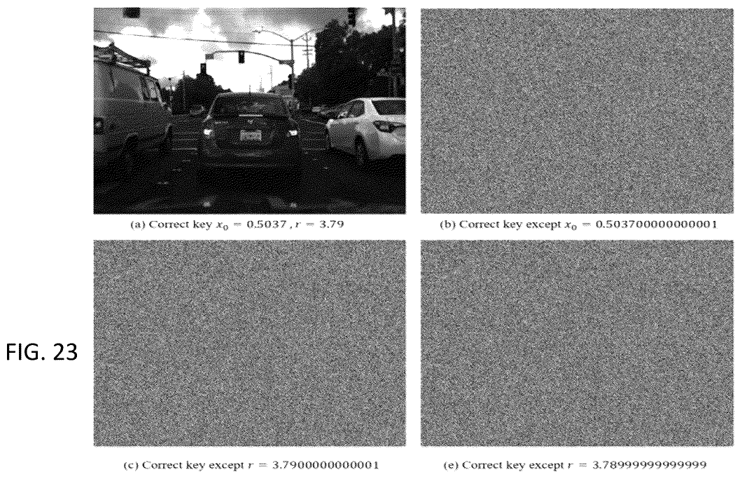

In embodiment, to effectively withstand a cryptanalysis attack, it is important for a strong encryption method to exhibit a high degree of sensitivity towards changes in both the plain images and the key components. Thus a high level of sensitivity to the key parameters is important. In embodiments, the described encryption process categorizes sensitivity into two distinct points: (1) if the values of the key parameters are changed during the encryption process, the image is substantially altered. Based on the results of this study, the allergy to the secret key in the proposed approach is adequate; and (2) the decrypted image will alter significantly depending on how slightly the key parameters change during the decryption process. FIG. 23 is a described process that indicates that the encryption process has sufficient key sensitivity.

In embodiments, the concept of plaintext sensitivity posits that even a minor alteration in the original image can result in a significant modification in the corresponding encrypted image. Accordingly, to create a cipher image, it is required to encrypt a plaintext image. Also, a pixel was picked at random from the same plaintext image, and then its value was altered. Lastly, the updated plaintext image was encrypted with the same encryption key to make a new encrypted image. In embodiments, the sensitivity of the system can be assessed through the utilization of two metrics: the Number of Pixels Change Rate (NPCR) and the Unified Average Changing Intensity (UACI), given by equations (9) and (10) as shown, respectively:

$$NPCR = \frac{1}{M \times N} {\sum }_{i = 1}^{M} {\sum }_{j = 1}^{N} D ( i , j ) \times 100 ( \% ) ,$$

$$UACI = \frac{1}{M \times N} {\sum }_{i = 1}^{M} {\sum }_{j = 1}^{N} \frac{\vert {I}_{c 2} ( i , j ) - {I}_{c 1} ( i , j ) \vert}{255} \times 100 ( \% ) ,$$

$$and ,$$

$$D ( i , j ) = \{ \begin{matrix}0 , & {I}_{c 2} ( i , j ) = {I}_{c 1} ( i , j ) , \\ 1 , & {I}_{c 2} ( i , j ) \neq {I}_{c 1} ( i , j )\end{matrix}$$

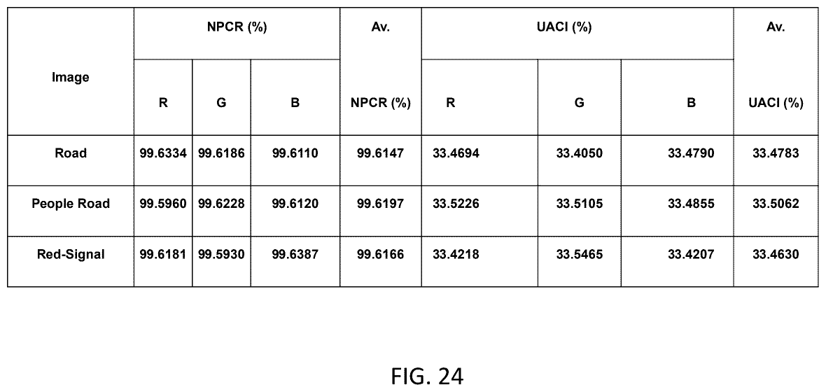

In embodiments, I_{c1} and I_{c2} are cipher images encrypted from the same original image and one pixel changed, respectively. As shown in FIG. 24, the table shows the NPCR and UACI values, which are very near to their respective theoretical values of 99.6% and 33%, respectively. As a result, the described encryption process indicates that it is highly sensitive to plaintext and is therefore more resistant to statistical attacks.

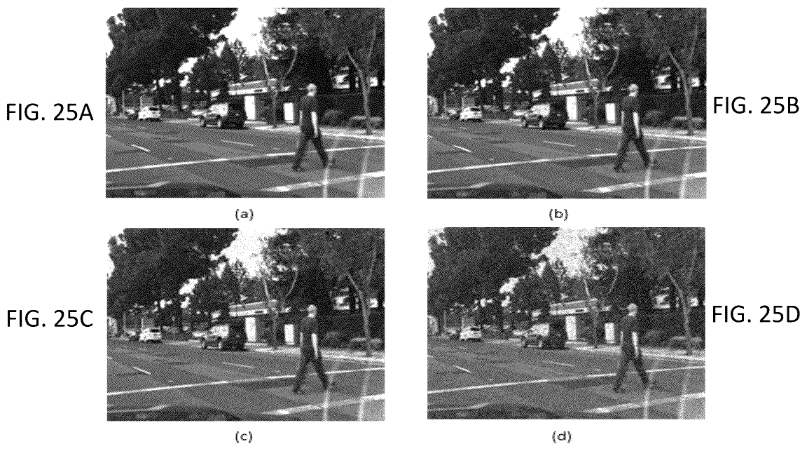

When encrypted images are sent over the network, they can be attacked. An effective encryption method should successfully recover images after such attempts. During a noise assault, the pixel values of some cipher pictures may undergo alterations as a result of faults occurring in the transmission channel. Accordingly, it is imperative for a robust encryption algorithm to be unaffected by such noise disturbances. The impact of a noise attack on the cipher image resulting from the encryption technique as shown in FIGS. 25A-25D whereby “salt-and-pepper” noise is introduced. In embodiments, the described encryption system has a strong resistance against noise-based attacks, as evidenced by the retention of visual information from the plaintext image in the decrypted image of the noisy cipher. Noise attacks are implemented to assess the robustness of our proposed approach and check its effectiveness through the quantification of the Mean Square Error (MSE) and peak Signal-to-Noise Ratio (PSNR). The Mean Squared Error (MSE) is commonly employed as a metric for quantifying the average discrepancy between observed values OI and predicted values DI. Where variable OI represents the original image that has undergone encryption, while DI represents the decrypted image resulting from the addition of varying-density noise to the encrypted image. The mean squared error (MSE) is computed by equation (12) as:

$$MSE = \frac{1}{M \times N} {\sum }_{i = 1}^{M} {\sum }_{j = 1}^{N} {( {O}_{1} ( i , j ) - D ( i , j ) )}^{2}$$

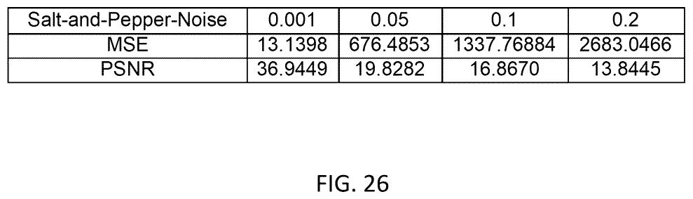

In embodiments, PSNR is a parameter for assessing the degree of matching between O_{I} and D_{I} and is calculated as follows (and shown in equation (13):

$$PSNR = 10 {log}_{2} \frac{{I}^{2} max}{MSE}$$

where I² is the greatest value of pixel image. The PSNR parameter is preferred to be low when comparing the significant difference between the unencrypted and encrypted image. As described in FIG. 26, the table along with FIGS. 25A-25D demonstrates that the lower MSE values derived from equation (12) indicate the smallest possible decryption error. The higher PNSR values derived from equation (13) indicate that the decrypted image for the altered cipher images containing (salt & pepper) noise is more faithful to its plaintext image. The findings indicate that encryption techniques provide sufficient security against noise-based attacks.

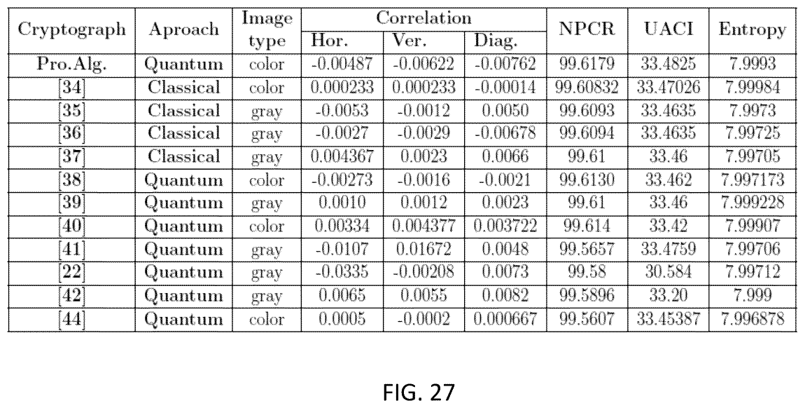

As shown in FIG. 27, the described table presents a comprehensive comparison between the proposed image encryption mechanism and previously utilized methods. Performance measures, including correlation coefficients and differential measures such as NPCR, UACI, and encryption entropy, were estimated using standard test images. Each technique offers distinct advantages. The comparison reveals that the proposed method induces the highest level of randomness in the correlation coefficient of encrypted adjacent pixels across horizontal, vertical, and diagonal directions, surpassing other methods. While all compared techniques meet the standard criterion for NPCR and UACI values, the described encryption process achieves the best values of 99.6179 and 33.4825, respectively. As a result, the described encryption process exhibits greater resistance to various differential attacks compared to alternative approaches.

In addition, the encryption processes' color technique is better in terms of differential attack and correlation coefficient since the value of NPCR is 99.6179, while the classical approach is 99.60832. Moreover, it is evident from the table described in FIG. 27 that the NPCR value is 99.6179 from the described encryption process, while previous processes are 99.6130,99.614 and 99.5607, respectively. This clearly demonstrates the effectiveness of the proposed technique against brute force differential and noise attacks. Furthermore, the entropy values for these four algorithms are 7.9993, 7.997173, 7.99907 and 7.996878, respectively. This indicates that the proposed algorithm is the most efficient approach to encrypt color images, showcasing a heightened level of randomness that proves its dependable capabilities, superiority, and resilience against a range of attacks.

Accordingly, the proposed quantum encryption process surpasses other state-of-the-art models in various aspects. These include a higher correlation coefficient, improved differential measures, enhanced key sensitivity, and a substantial key space. The key space for the initial parameters is both extensive and adequately random, further reinforcing the superiority of the proposed model.

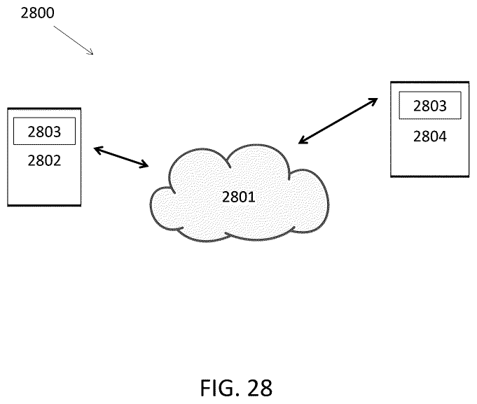

FIG. 28 is a diagram of example environment 2800 in which systems, devices, and/or methods described herein may be implemented. FIG. 28 shows network 2801, application 2803, user device 2802 and user device 2804. Network 2801 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 2801 may include a cellular network, a public land mobile network (PLMN), a second generation (2G) network, a third generation (3G) network, a fourth generation (4G) network, a fifth generation (5G) network, and/or another network.

In embodiments, network 2801 may allow for devices describe any of the described figures to electronically communicate (e.g., sending color images, blockchains, bitcoins, using emails, electronic signals, URL links, web links, electronic bits, fiber optic signals, wireless signals, wired signals, etc.) with each other so as to send and receive various types of electronic communications.

User device 2802 and/or 2804 may include any computation or communications device that is capable of communicating with a network (e.g., network 2801). For example, user device 2802 and/or user device 2804 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 2802 and/or 2804 may receive and/or display content. The content may include objects, data, images, audio, video, text, files, and/or links to files accessible via one or more networks. Content may include blockchains and/or other types of distributed ledgers. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 2802 and/or 2804. User device 2802 and/or 2804 may have a touch screen and/or a keyboard that allows a user to electronically interact with an electronic application. In embodiments, a user may swipe, press, or touch user device 2802 and/or 2804 in such a manner that one or more electronic actions will be initiated by user device 2802 and/or 2804 via an electronic application.

User device 2802 and/or 2804 may include a variety of applications, such as, for example, a blockchain-based application, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.). In embodiments, user device 2802 and/or 2804 may receive blockchains without using an associated application (such as electronic application 2803).

Electronic application 603 may be capable of interacting with user device 2802 and/or user device 2804 to send and/or receive color images that can be encrypted or decrypted for sending between user device 2802 and 2804. In embodiments, electronic application 2803 may be electronically configured connect to a vehicle and be able to send and receive electronic information, such as images, to other vehicles that have user device 2802 or 2804.

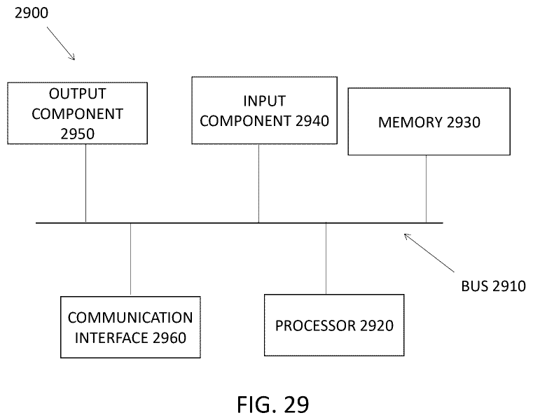

FIG. 29 is a diagram of example components of a device 2900. In embodiments, the blockchain/distributed ledger descriptions may be stored across multiple devices 2900. Device 2900 may correspond to a computing device, such as devices that may use the quantum circuits described in FIGS. 1-28. Device 2900 may be associated with user device 2902, user device 2904, and/or blockchain management system 2906. As shown in FIG. 29, device 2900 may include a quantum bus 2910, a processor 2920, a memory 2930, quantum input component 2940, quantum output component 2950, and a communications interface 2960. In other implementations, device 700 may contain fewer components, additional components, different components, or differently arranged components than depicted in FIG. 29. Additionally, or alternatively, one or more components of device 2900 may perform one or more tasks described as being performed by one or more other components of device 2900.

Bus 2910 may include a path that permits communications among the components of device 2900. Processor 2920 may include one or more processors, microprocessors, and/or processing logic (e.g., a field programmable gate array (FPGA), quantum teleportation devices, quantum communication devices, quantum computing circuits, quantum encryption applications and/or an application specific integrated circuit (ASIC)) that interprets and executes instructions. Memory 2930 may include any type of dynamic storage device that stores information and instructions, for execution by processor 2920, and/or any type of non-volatile storage device that stores information for use by processor 2920. Input component 2940 may include a mechanism that permits a user to convert classical information to quantum input information to device 2900, such as a quantum circuit, a quantum-based application, a keyboard, a keypad, a button, a switch, voice command, etc. Output component 2950 may include a mechanism that outputs information and transforms quantum information to classical information to be provided to the user, such as a display, a speaker, one or more light emitting diodes (LEDs), etc.

Communications interface 2960 may include any transceiver-like mechanism that enables device 2900 to communicate with other devices and/or systems. For example, communications interface 2960 may include an Ethernet interface, an optical interface, a coaxial interface, a wireless interface, or the like and quantum-to-classical and vice versa unit.

In another implementation, communications interface 2960 may include, for example, a transmitter that may convert baseband signals from processor 2920 to radio frequency (RF) signals and/or a receiver that may convert RF signals to baseband signals. Alternatively, communications interface 2960 may include a transceiver to perform functions of both a transmitter and a receiver of wireless communications (e.g., radio frequency, infrared, visual optics, quantum wireless, quantum channels, quantum fiber optics, quantum teleportation, quantum communication devices/networks, quantum encryption devices, etc.), wired communications (e.g., conductive wire, twisted pair cable, coaxial cable, transmission line, fiber optic cable, waveguide, single-photon channels, multi-photon channels, etc.), or a combination of wireless and wired communications.

Communications interface 2960 may connect to an antenna assembly (not shown in FIG. 29) for transmission and/or reception of the RF signals, and/or quantum channels. The antenna assembly may include one or more antennas to transmit, quantum channels and/or receive RF signals over the air. The antenna assembly may, for example, receive RF signals and/or quantum information from communications interface 2960 and transmit the RF signals over the air, and receive RF signals over the air and provide the RF signals to communications interface 2960. In one implementation, for example, communications interface 760 may communicate with a network (e.g., a wireless network, quantum network, quantum channel, wired network, Internet, quantum internet, etc.). In embodiments, an antenna may be implemented by quantum teleportation protocols, quantum communication protocols and/or quantum encryption protocols.

As will be described in detail below, device 2900 may perform certain operations. Device 2900 may perform these operations in response to processor 2920 executing software instructions (e.g., computer program(s)) contained in a computer-readable medium, such as memory 2930, a secondary storage device (e.g., hard disk, CD-ROM, etc.), or other forms of QRAM, RAM or ROM. A computer-readable medium may be defined as a non-transitory memory device. A memory device may include space within a single physical memory device or spread across multiple physical memory devices. The software instructions may be read into memory 2930 from another computer-readable medium or from another device. The software instructions contained in memory 2930 may cause processor 2920 to perform processes described herein. Alternatively, hardwired circuitry may be used in place of or in combination with software instructions to implement processes described herein. Thus, implementations described herein are not limited to any specific combination of hardware circuitry and software.

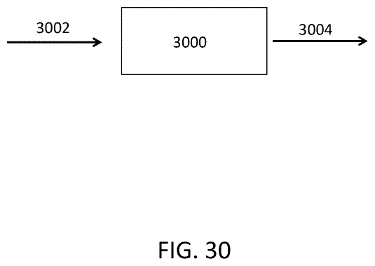

FIG. 30 is an example diagram of a computing device 3000. FIG. 30 describes device 3000, input 3002, and output 3004. In embodiments, device 3000 may a computing device with features/structures similar to that described in FIG. 30. In embodiments, device 3000 may be a computing device that is part of a laptop, desktop, tablet, smartphone, quantum computer, quantum computing device, quantum communication device, quantum teleportation device, quantum encryption device, quantum internet device, and/or any other device. In embodiments, device 3000 may receive communication 3002, analyze communication 3002, and generate output 804.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing, electronic networking, quantum computing and/or quantum networking environment (such as described in FIG. 28) and may require one or more computing devices, as described in FIG. 29 or FIG. 30 to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices, quantum computer, cloud quantum circuit/computer, quantum communication devices, quantum teleportation devices, quantum encryption circuit/devices, and/or quantum networks. Also, it will be understood that any of the various actions can result in any type of electronic information and/or quantum information to be displayed in real-time and/or simultaneously on multiple user devices. Any electronic graphs and/or quantum information may be generated by a computing device, such as device 700, and displayed via a graphical user device (GUI) or cloud environment.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
reading, by a quantum circuit, an image;
converting, by the quantum circuit, the image into two quantum identical plain images;
constructing, by the quantum circuit, the image;
generating, by the quantum circuit, a quantum encrypted key based on a degree of entanglement;
applying, by the quantum circuit, 24 of CNOT gates between qubits of a quantum image and qubits of a quantum key to obtain a quantum encrypted image;
measuring, by the quantum circuit, the quantum encrypted image;
generating, by the quantum circuit, a new quantum key;
applying, by the quantum circuit, 24 CNOT gates between the qubits of the three registers of the quantum image as control qubits, and the corresponding qubits of the three registers, respectively, of the quantum key as target qubits,
wherein the applying the 24 CNOT gates generates a second level of the quantum-encrypted image;
applying, by the quantum circuit, 24 of CNOT gates between each qubit of the quantum scrambling image as the control qubits and its corresponding qubit in the quantum key as the target qubits; and obtaining, by the quantum circuit, a quantum ciphered image |I_{c} [symbol] .

2. The method of claim 1, wherein the new quantum key is used in a quantum diffusion operation, and wherein the quantum confusion operation enhances a security level of the quantum encrypted image derived from the encryption image, and wherein a new version of the quantum-encrypted.

3. A method, comprising:
reading by a quantum circuit, a quantum ciphered image |I_{c} [symbol] , wherein the quantum ciphered image |I_{c} [symbol] is used for decryption;
measuring, by the quantum circuit, the quantum ciphered image |I_{c} [symbol] ;
transforming, by the quantum circuit, the quantum ciphered image |I_{c} [symbol] into a classical encrypted image, wherein the classical encrypted image is denoted as I_{c};
retrieving, by the quantum circuit, the classical encrypted image size as the total number of pixels MN, wherein the MN represents a total number of pixels in the classical encrypted image;
generating, by the quantum circuit, a quantum decrypting key |C₁ [symbol] by re-executing a MzKeyG algorithm and also based on the classical encrypted image;
converting, by the quantum circuit, the classical ciphered image I_{c} into a quantum non-ciphered image; and
generating, by the quantum circuit, a first round of the quantum decryption phase, |I_{D1} [symbol] , by applying 24 CNOT gates between qubits of three registers.

4. The method of claim 3, further comprising:
reversing, by the quantum circuit, a reverse quantum plain scrambling (QPS) operation of the quantum decryption image |I_{D1} [symbol] is conducted and uses a set of 40 CNOT gates between qubits as the same as an encryption process;
measuring, by the quantum circuit, the quantum image |I_{D1} [symbol] in the computational basis, resulting in the transformation of |I_{D1} [symbol] into a classical image I_{D1};
using, by the quantum circuit, the classical ciphered image I_{D1} and the parameters δ*, r and θ₀ to generate a quantum decrypting key |C₂ [symbol] by re-executing the MzKeyG algorithm; 4generating, by the quantum circuit, the second round of the quantum decryption phase, wherein the generating the second round of the quantum decryption phase results in a plaintext image |I [symbol] ; and measuring, by the quantum circuit, the plaintext quantum image |I [symbol] in the computational basis to obtain the classical original image I.

5. The method of claim 4, wherein the qubits are |I_{c}(Y^{R}, X^{R}) [symbol] , |I_{c}(Y^{G}, X^{G}) [symbol] , and |I_{c}(Y^{B}, X^{B}) [symbol] of the quantum non-ciphered image as control qubits, and corresponding qubits of the three registers, wherein the control qubits are |C₁(Y^{R}, X^{R}) [symbol] , |C₁(Y^{G}, X^{G}) [symbol] , and |C₁(Y^{B}, X^{B}) [symbol] of a quantum key |C₁ [symbol] as target qubits.

6. A method, comprising;
analyzing, by a quantum system, an image;
generating, by the quantum system, a one-dimensional chaotic logistic map based on the analyzing of the image
wherein the one-dimensional chaotic logistic map is a computer-based process that generate chaotic sequences;
generating, by the quantum system, chaotic values based on the one-dimensional chaotic logistic door;
generating, by the quantum system, sequence numbers stored in X, wherein X is an array of floating values that describe a full chaotic state;
generate, by the quantum system, a quantum encryption key stream for each pixel i based on the success probabilities of the basis states |0011 [symbol] , |1100 [symbol] , and the degree of entanglement measure, concurrence Cᵢ,
updating, by the quantum system, an angle θᵢ is by adding Xᵢ, where θ₀=0;
encoding, by the quantum system, θᵢ into a first qubit of a two-qubit system that is initialized in a vacuum state |00 [symbol] by the Y-rotation gate R_{y}(θᵢ) on the first qubit;
wherein a state of the two-qubit is
$$cos ( \frac{{θ}_{i}}{2} ) \vert 00 \cdot 〉 + sin ( \frac{{θ}_{i}}{2} ) \vert 10 \cdot 〉 .$$
generating, by the quantum system, four spreadable qubits as follows:
$$\vert ψ \cdot 〉 \vert ψ \cdot 〉 = {cos}^{2} ( \frac{{θ}_{i}}{2} ) \vert 0000 \cdot 〉 + cos ( \frac{{θ}_{i}}{2} ) sin ( \frac{{θ}_{i}}{2} ) \vert 0010 \cdot 〉 + cos ( \frac{{θ}_{i}}{2} ) sin ( \frac{{θ}_{i}}{2} ) \vert 1000 \cdot 〉 + {sin}^{2} ( \frac{{θ}_{i}}{2} ) \vert 1010 \cdot 〉 .$$
applying, by the quantum system, the Mz operator on the four spreadable qubits, by applying two CNOT gates that entangle two decoupled replicas of |ψ [symbol] |ψ [symbol] ;
determining, by the quantum system, a concurrence value Cᵢ,
wherein the Mz operator uses the classical chaotic value θᵢ to generate a key stream of three encryptions keys; and
applying. by the quantum system, any of the three encryption keys are used to encrypt the imagc.

7. The method of claim 6. wherein the three encryption keys are a quantum key generation algorithm (MzKeyG).
